(19) United States
(12) Patent Application Publication
(10) Pub. No.: US 2003/0040953 A1
(43) Pub. Date: Feb. 27, 2003

(54) Sales call wizard

(75) Inventors: Kraig J. Kasler, North Ridgeville, OH (US); Joseph R. Melchiors, Aurora, OH (US); Denise Marcolongo, Avon Lake, OH (US)

Correspondence Address: Timothy E. Nauman, Esq., Fay, Sharpe, Fagan, Minnich & McKee, LLP, 7th Floor, 1100 Superior Avenue, Cleveland, OH, 44114-2518, US

(73) Assignee: GENERAL ELECTRIC COMPANY

(21) Appl. No.: 09/938,938

(22) Filed: Aug. 24, 2001

(51) Int. Cl. G06F 17/60

(52) U.S. Cl. 705/10

(57) ABSTRACT

A tool which generates sales presentations, includes a sign-in page configured to authenticate an approved user of the tool. A pre-call data page lists a plurality of selectable market segments, where selection of one of the market segments generates a pre-call data sheet related to the selected market segment. A lead page is configured to include a selectable new lead button and a selectable existing lead button. A new lead button data entry page is linked to the new lead button having defined data entry requirements to permit generation of a new lead. An existing lead page is linked to the existing lead button and is designed with a listing of existing leads callable by a user. A lead generation page will generate a first-call presentation dynamically using data entered by the user. A follow-up call data entry page includes data entry sections which allow for the entry of data specific to a customer. The data being entered in the follow-up call data entry page is data obtained during the presentation of the first call sales presentation. A product replacement page generates replacements or up-grade products for a customer based on the input data, and a follow-up sales presentation page generates a follow-up sales presentation dynamically using the data entered by the user for presentation to the end-user or customer.

### BACKGROUND OF THE INVENTION

The present invention relates to the generation of sales presentations shown to a customer, and more particularly to a tool which permits the generation of customized presentations generated by integrating expertise in specific areas.

When a sales representative or distributor approaches a potential customer, it is common that the customer is presented with a formal sales presentation, which may, for example, include informative slides. An existing process for generating these sales presentations is for the sales representative or distributor to use a system such as PowerPoint (a product of Microsoft Corporation) to generate the presentation. The user creates individual slides, or use slides previously generated. The user then selects what slides are to be in the presentation, and how the slides are arranged to make the most convincing presentation.

Numerous drawbacks exist with the existing techniques. These include an over-reliance on the party or user putting together the sales presentation. More specifically, a large organization may sell products for a large number of different market segments. It is unreasonable to believe that a sales representative handling each of the product lines will be an expert and understand each market segment. This will result in the generation of either erroneous or ineffective sales presentations due to the user's lack of knowledge or expertise in that specific area. Also, the putting together of sales presentations are time consuming to the user. Specifically, the user will be generating their own slides, and selecting an order in which the slides are presented. Such presentations are started from scratch. The lack of a common starting point increases the chance the user will make unsupportable claims regarding products or select products which are inappropriate.

Further, when existing slides from previous presentations exist, they are often not easily accessible by the user, as they are located on a disk or on a computer of a person who has previously made a presentation. Further, these pre-made slides may be out of date presenting inappropriate information.

In view of the foregoing, it is considered desirable to create a sales presentation tool which has the ability to make customized end user product recommendations, and to generate them into a presentation which is accessible both by an internal computer network such as an Intranet network and through external sources such as the Internet. It is also desirable to provide flexibility where such a system is configured to be used in a wireless environment as well as wire line. A useful tool would also dynamically generate presentations using real-time data entry by a user, and will integrate tools which allow for assisting the user to present the customer with information. These integrated tools could include determining the cost of its lighting needs, as well as providing information to the management of the user's company as to what point the user is within the sales process.

### BRIEF DESCRIPTION OF THE INVENTION

A tool which generates sales presentations, includes a sign-in page configured to authenticate an approved user of the tool. A pre-call data page lists a plurality of selectable market segments, where selection of one of the market segments generates a pre-call data sheet related to the selected market segment. A lead page is configured to include a selectable new lead button and a selectable existing lead button. A lead in the context of this document is defined as a sales lead throughout. A new lead button data entry page is linked to the new lead button having defined data entry requirements to permit generation of a new lead. An existing lead page is linked to the existing lead button and is designed with a listing of existing leads callable by a user. A lead generation page will generate a first-call presentation dynamically using data entered by the user. A follow-up call data entry page includes data entry sections which allow for the entry of data specific to a customer. The data being entered in the follow-up call data entry page is data obtained during the presentation of the first call sales presentation. A product replacement page generates replacements or up-grade products for a customer based on the input data, and a follow-up sales presentation page generates a follow-up sales presentation dynamically using the data entered by the user for presentation to the end-user or customer.

### BRIEF DESCRIPTION OF THE DRAWINGS

FIGS. 1-3 depict a flowchart for one embodiment of the Sales Call Wizard tool according to the present invention;

FIG. 4 illustrates an initial Start New Lead screen generated by the flowcharts of FIGS. 1-3;

FIG. 5 illustrates a pre-call entry screen;

FIG. 6 is a portion of a pre-call data sheet (cheat sheet);

FIG. 7 sets forth the Open Existing Lead screen generated by the present invention;

FIG. 8 is a screen depicting data entry for generation of a first call sales presentation;

FIG. 9 depicts a page immediately prior to generation of the first call presentation;

FIG. 10 illustrates the screen following generation of the presentation;

FIG. 11 sets forth a data input screen for product and customer need selections for the generation of a follow-up call presentation;

FIG. 12 illustrates a matrix depicting those products generated by the system as replacement or upgrade products for inclusion within the follow-up call presentation;

FIG. 13 depicts a screen for the generation of the follow-up call presentation;

FIG. 14 is the cover page of one type of follow-up presentation;

FIG. 15 shows a slide from a follow-up sales presentation showing an existing product and a recommended replacement product generated by the sales call tool;

FIG. 16 is a flowchart for the value lighting auditing software of the present invention;

FIG. 17 integrates an opportunity management system which is required to be implemented upon operation of the tool;

FIG. 18 depicts the optional inclusion of the running of an opportunity management system in the present embodiment;

FIG. 19 depicts another optional inclusion of the running of an opportunity management system in the present embodiment;

FIG. 20 depicts one hardware arrangement for implementation of the present invention.

### DETAILED DESCRIPTION OF THE INVENTION

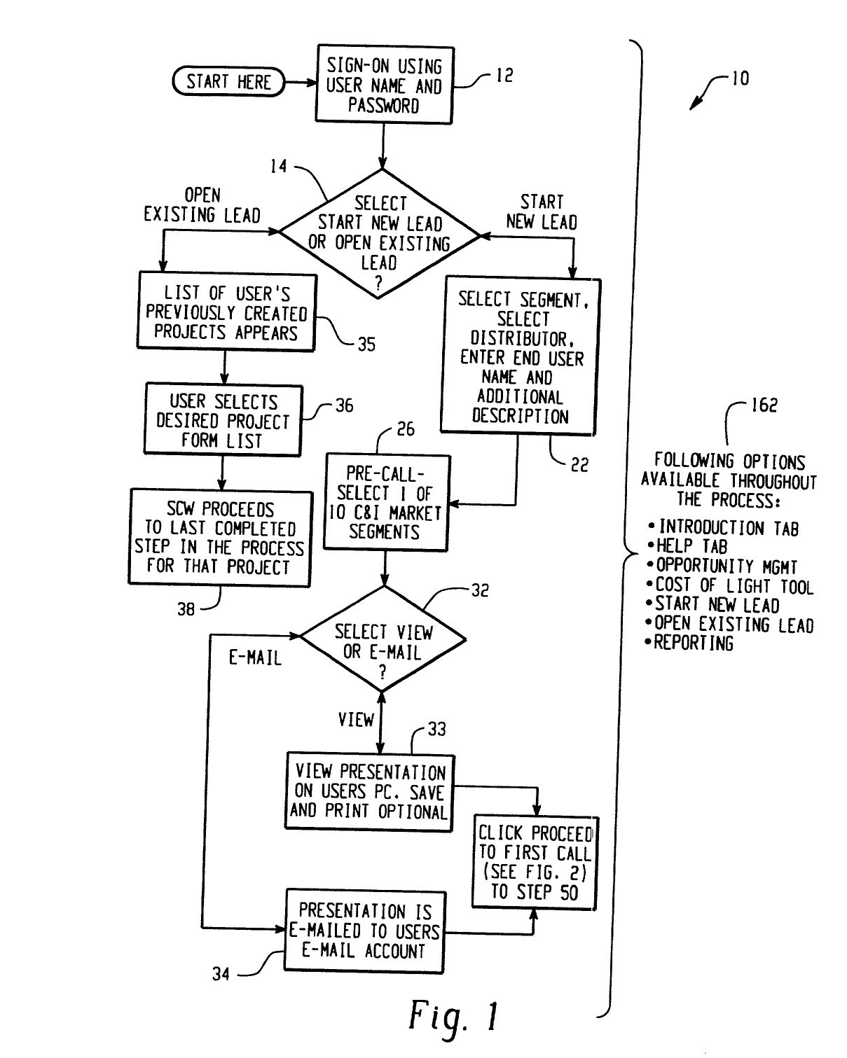

FIGS. 1-3 set forth a flow chart illustrating one embodiment in which a Sales Call Wizard (SCW) tool 10 of the present invention is implemented. The SCW tool 10 may be deployed via an Internet or Intranet configuration, and is accessible both by wire line and wireless communications.

Upon initiation, a sign-in step 12 is undertaken where a user is prompted to enter a user identification (ID) and personal password. Authentication is achieved via known authentication techniques and in one embodiment may be obtained against the LDAP or exchange server, and SiteMinder (a trademark of Netegrity, Inc.) or other appropriate program performs authentication operations.

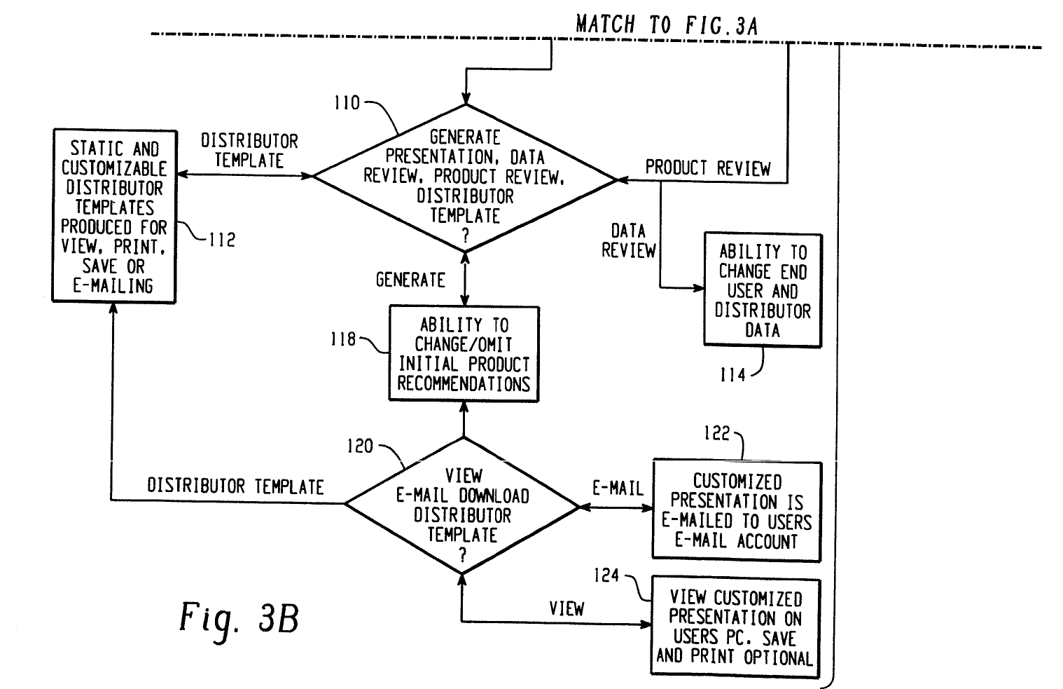

Once the user has been authenticated by the network, the process moves to decision step 14 where, by default, a Sales Call Wizard (SCW) New Lead page 16 is displayed, as shown in FIG. 4. SCW screen 16 includes a Start New Lead button 18, and an Open Existing Lead button 20 which allow a user to move into the SCW tool 10 at various points. On initial entry to decision step 14, Start New Lead button 18 is highlighted as if selected by default. It is to be appreciated that the screen layouts, designs and defaults are for a specific embodiment, and that the present invention may be implemented using other screen embodiments and visual arrangements.

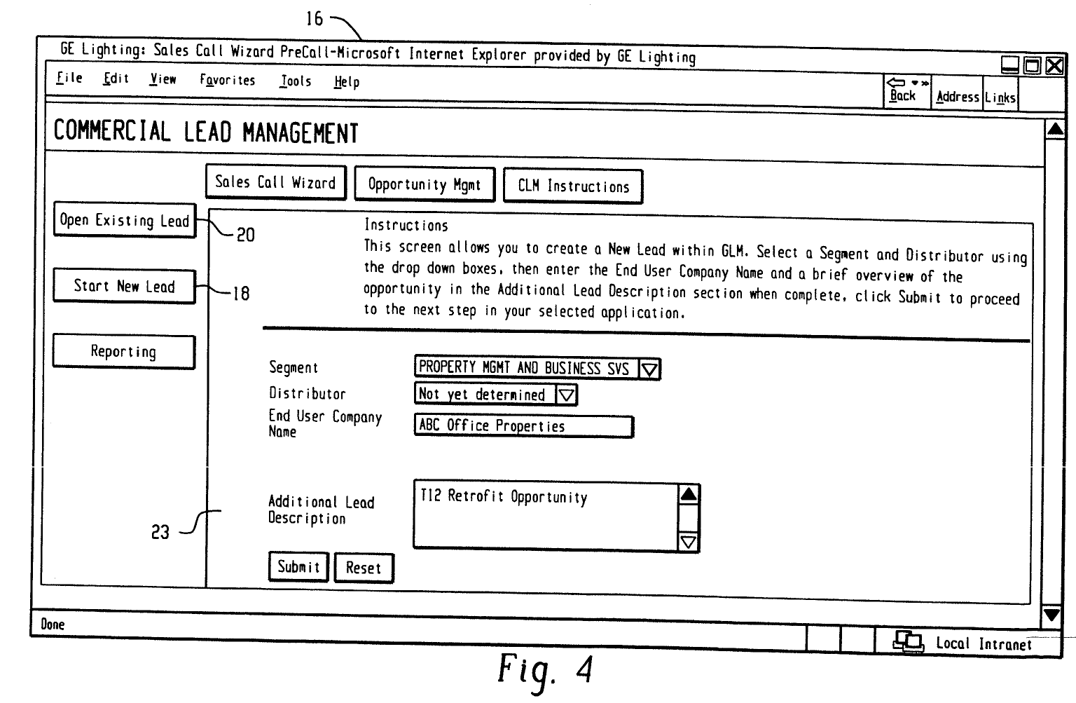

As shown in FIG. 1, once a user has selected the Start New Lead button 18 or accepts the default selection of button 18, the process moves to step 22, where SCW tool 10 displays New Lead page 16, and a user may then select one of the market segments, select a distributor, enter an end user name and enter additional description. In this example, the user has selected the Property Management and Business Services segment, included in a data entry field 23 for entry of lead data, which is a first step in generating a customized presentation. A user preferably may not move to a pre-call entry page 24, as shown in FIG. 5, without entering the data as shown in FIG. 4.

Upon completion of the lead data shown in FIG. 4, the process moves to pre-call step 26 where a user selects one of the market segments displayed on entry page 24. In this example the Property Management and Business Services segment 28 of FIG. 5 has been selected. Also displayed on entry page 24 is a sales procedure timeline 29 including distinct stages within SCW tool 10. While at pre-call stage 30, SCW page 24 includes a View Pre-call Sheet tab 31, Start New Lead button 18 and Open Existing Lead button 20. The process flow of FIG. 1 then moves to decision step 32 where the user selects by means of View button and E-mail button on entry page 24 whether a corresponding pre-call data sheet or “cheat sheet” should be viewed or e-mailed. In FIG. 5, it is assumed here that the selection has been to view the pre-call data sheet.

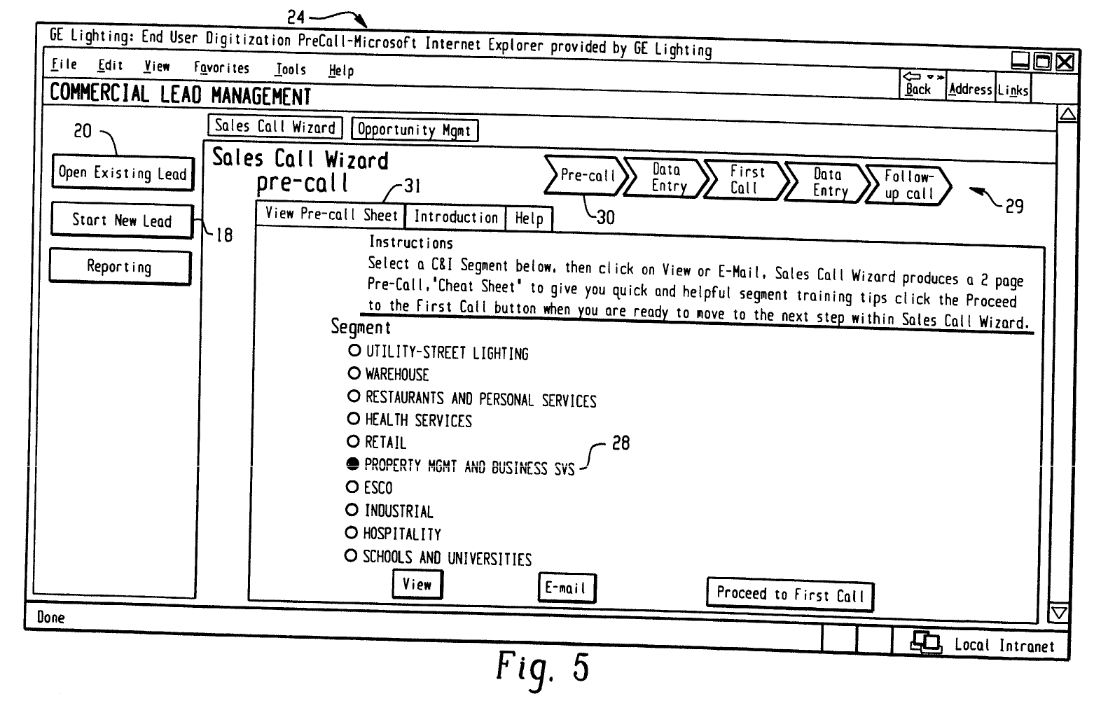

Turning to FIG. 6, shown is a portion of an exemplary pre-call data sheet which provides a user with expert advice related to Property Management segment 28. The advice provided to the user includes information on how to begin the sales process, including how to find a prospect, whether it would be financially worthwhile to visit with the prospect, benefits the company brings to a customer, as well as important items to know about the industry. The data sheet may also include other pieces of expert advice including, who to talk to within the company, products which may be of interest for that particular market segment and areas where the user may gain even further information regarding this market. Such data sheets are valuable, especially in organizations which either have a varied product line and/or sell to customers having a large variety of needs. Particularly, the data sheet assists someone who may be knowledgeable in the sales process but is not versed in the specific market segments.

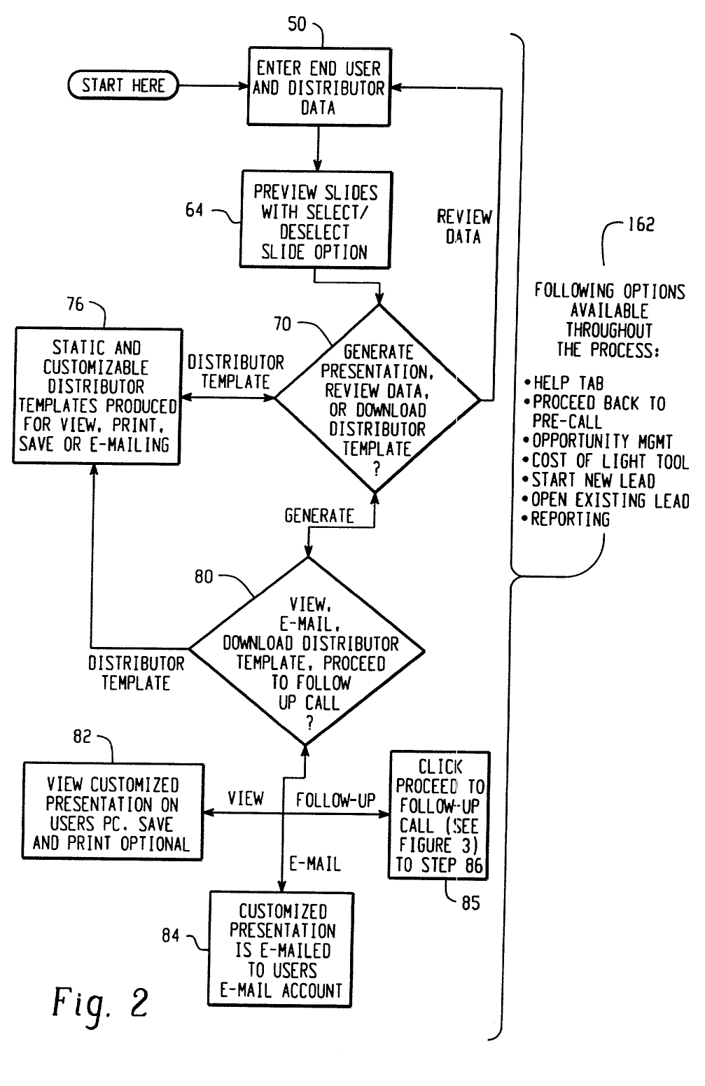

The data sheet of FIG. 6 is provided to a user's computer, as shown in step 33, when the View button is selected in FIG. 5, and may then be saved or printed. An optional selection in step 32 is to request the pre-call data sheet to be e-mailed to the user's account, step 34. After viewing or e-mailing the pre-call data sheet, a user may select a Proceed to First Call button in FIG. 5. This procedure will be explained later in conjunction with FIG. 2.

Returning to FIG. 1, at step 14, instead of the user selecting viewing of the New Lead page 16, an alternative is to open existing leads of the user by selection of Open Existing Lead button 20 of FIG. 4. Selection of this option, causes SCW tool 10 to list a user's previously created leads, step 35. The user can then select a desired lead from a displayed list, step 36. Leads in this embodiment are defined as sales presentations. Upon selection of a specific lead, SCW tool 10 proceeds to the last completed step for that specific lead, step 38. Thereafter the user may complete generation of the sales presentation.

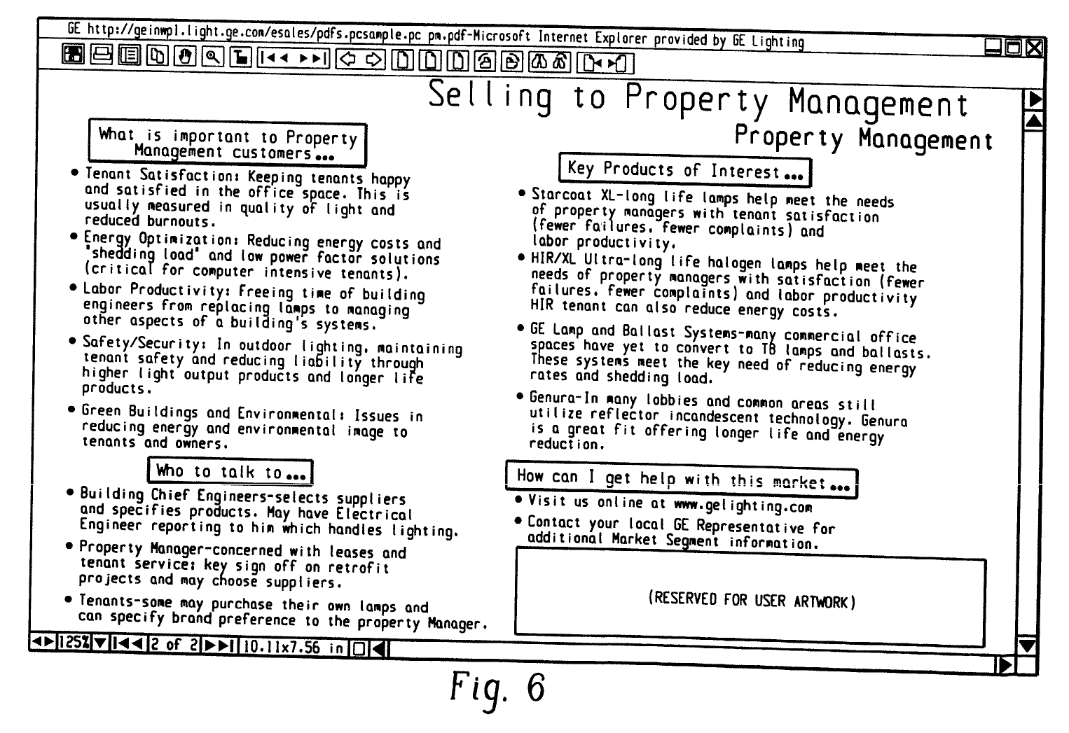

FIG. 7 is a screen of SCW tool 10 wherein Open Existing Lead button 20 has been selected, and an Open Lead section 40 for a user is shown. Open Lead section 40 is a chart listing existing sales presentation leads, a description section, the market segment to which it is related, an ID for the leads and system activity to date. The system activity to date displays the word ADD if there has been no activity for that lead, and displays the word EDIT if there has been previous activity for that lead. The system activity to date is further categorized by sales call wizard and opportunity management. It is to be appreciated that in this embodiment only the user which has logged in has access to the leads. It is of course possible to arrange the present system to permit others to also have such access. Once the user selects a lead, either using a mouse or other selection device, completion of, review or revising of a lead can be accomplished.

In an alternative embodiment, the information in the open lead section 40 is linked to a database whereby updates to the leads may be achieved. Particularly, if for Lead 17957, the HOSPITALITY presentations have been updated or revised after the generation of Lead 17957, the revision or update may be automatically inserted into the previously generated presentation. Alternately, first calls and follow-up calls may be regenerated by action of the user. Similarly, links to the specific lead may also update previously selected slides. For example, if Lead 17957 in FIG. 7 included slides for a specific product, and that product has been updated such that the slide has been revised within the database, linking to the database allows for an automatic updating of the slide information.

In an alternative embodiment, the user may be presented with an option of updating the material. The automatic updating feature is implemented through known linking techniques, where in one embodiment, for example, the code generating the screens has embedded therein steps to identify the updating of the screens and which lead I.D.s contain a particular slide.

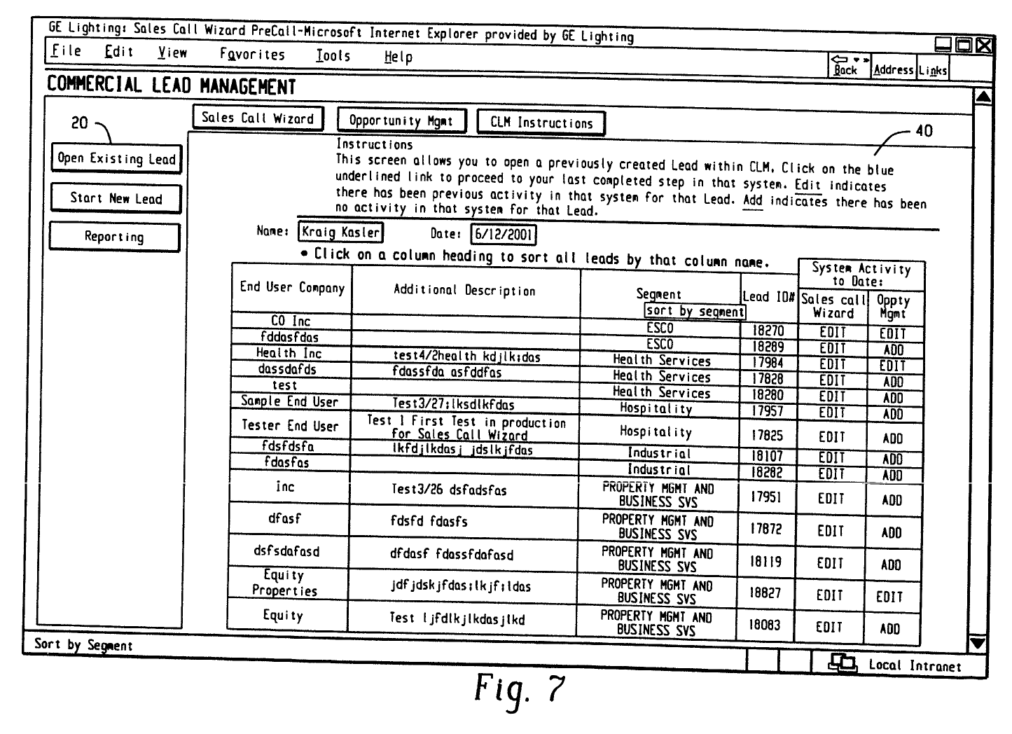

Turning to the SCW flow chart in FIG. 2, once a user clicks the proceed to first call button as shown in FIG. 5, the user is prompted to enter end user and distributor data, step 50. FIG. 8 illustrates one embodiment of a screen sufficient to receive this input. As can be seen, the sales procedure timeline 29 has now moved from the pre-call stage 30 to the Data Entry stage 52. When the Enter Call Information tab 54 is selected, the user is provided with End User Data entry (in this application end user is also referred to as a customer) fields 56 and distributor data fields 58. This information is used to create the front cover sheet of a customized first call sales presentation. Certain information such as the date of the first call and the end user information is, in this embodiment, mandatory fields and if not filled in the process will not continue.

Selection of the Reset button removes the information from the end user and distributor information spaces. Once this information has been correctly entered, selection of the Submit button causes the process to move forward.

SCW tool 10 is shown to be interactive with the user's real time inputs. Specifically, the end user and distributor information is saved by the tool in the system database and is tagged for insertion upon the generation of the screen shown in FIG. 8. Thus, in one embodiment, lead information (as well as other entered data) is stored in the system database with embedded or attached instructions which permit the data to be dynamically copied into the informational fields of other screens.

Returning attention to the flow chart of FIG. 2, following entry of the end user and distributor data, SCW tool 10 allows for a preview of the slides with a select and deselect slide option, step 64.

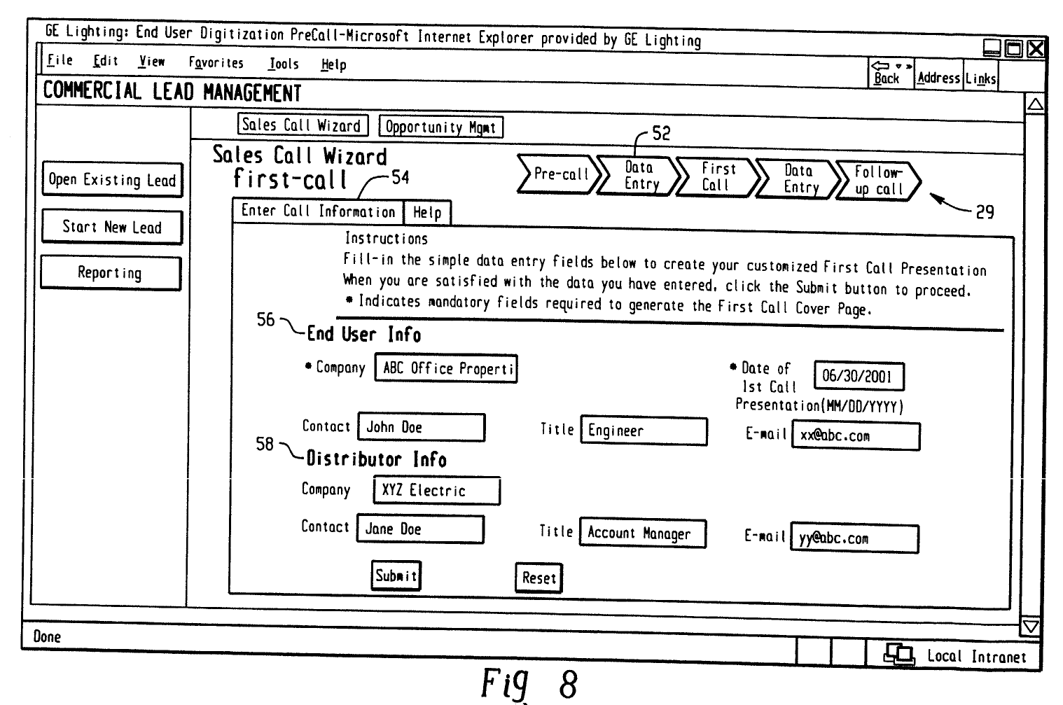

As may be noticed in FIG. 9, the sales procedure timeline 29 has moved to the First Call stage 66. Using the information received in the data entry portion of the process, a first call presentation can be generated for the specific market segment previously selected. The slides for the presentation are displayed in a slide segment description section 68, and the user may select slides via a mouse or other selection device in order to preview the slides.

Once this procedure is complete, the process moves to decision step 70. At this point, the user is provided with the option of selecting Review Data tab 72 of FIG. 9 to review the previously submitted data. Selection of Review Data tab 72 moves the process of FIG. 2 back to step 50.

Alternatively, the user may request a distributor template, or a blank template for free-form data entry, by selecting the Distributor Templates tab 74. This causes the process of FIG. 2 to move to step 76 where a distributor template is downloaded for entry into the sales presentation. The user can then print, save or e-mail the distributor presentation which now includes the distributor data. Often the sales representative of the company manufacturing the product may attend the sales meeting with a distributor. Alternatively the distributor themselves may make the sales call presentation. In order to further customize the sales presentation, information regarding the distributor can be included when appropriate. Downloading of the distributor template therefore provides a further level of customization.

An alternative provided at decision step 70 is to proceed with the generation of the customized first call presentation. For example, once the user is satisfied with the data entered during the data entry for the first call presentation, selection of Generate button 78 in FIG. 9 causes SCW tool 10 to automatically generate a presentation in an appropriate format, such as PDF or HTML format, dependant upon the data entered and the selected market segment.

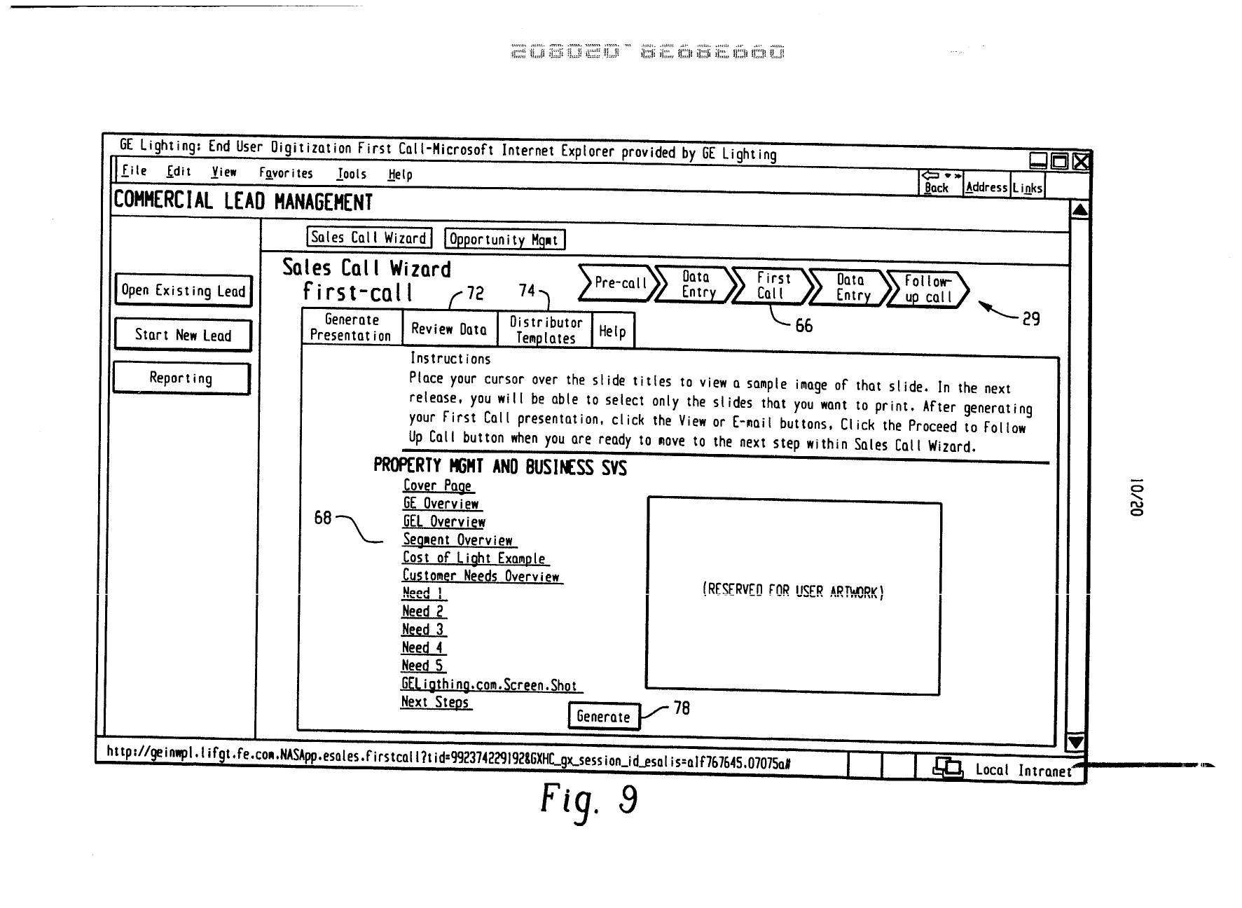

By these processes, SCW tool 10 is shown to be interactive and capable of accepting real-time data for the generation of a customized sales call presentation. As shown in decision step 80 of FIG. 2, once the customized sales presentation has been generated, the user has options to view and/or e-mail the customized presentation, by selection of the View or E-mail buttons of FIG. 10.

As a further alternative, if upon viewing the customized presentation the user wishes to now download a distributor template, or a blank template for free-form data entry, such an option is available by selection of the Distributor Templates tab in FIG. 10, which will result in the process returning to step 76. The process then moves from step 76 back to step 70, where a user may select to review the data, generate the presentation or download another distributor template.

Once a finalized customized sales presentation has been generated, the user may move to view the presentation, step 82, to e-mail the presentation, step 84, or to proceed to follow-up call, step 85. This is achieved by selection of the appropriate View, E-mail or Proceed to Follow Up Call buttons as shown in FIG. 10.

As a next step in the overall sales process, the user will meet with the customer either electronically or in person, for the initial or first sales call. During this meeting the user presents the customized first call presentation, and obtains more specific information regarding the requirements of the customer. This new data is used for the generation of a follow-up presentation which more specifically focuses on the end user's needs. Particularly, during the meeting the user (e.g. Sales Rep or Distributor) will determine the types of products used by the end user and other end user needs.

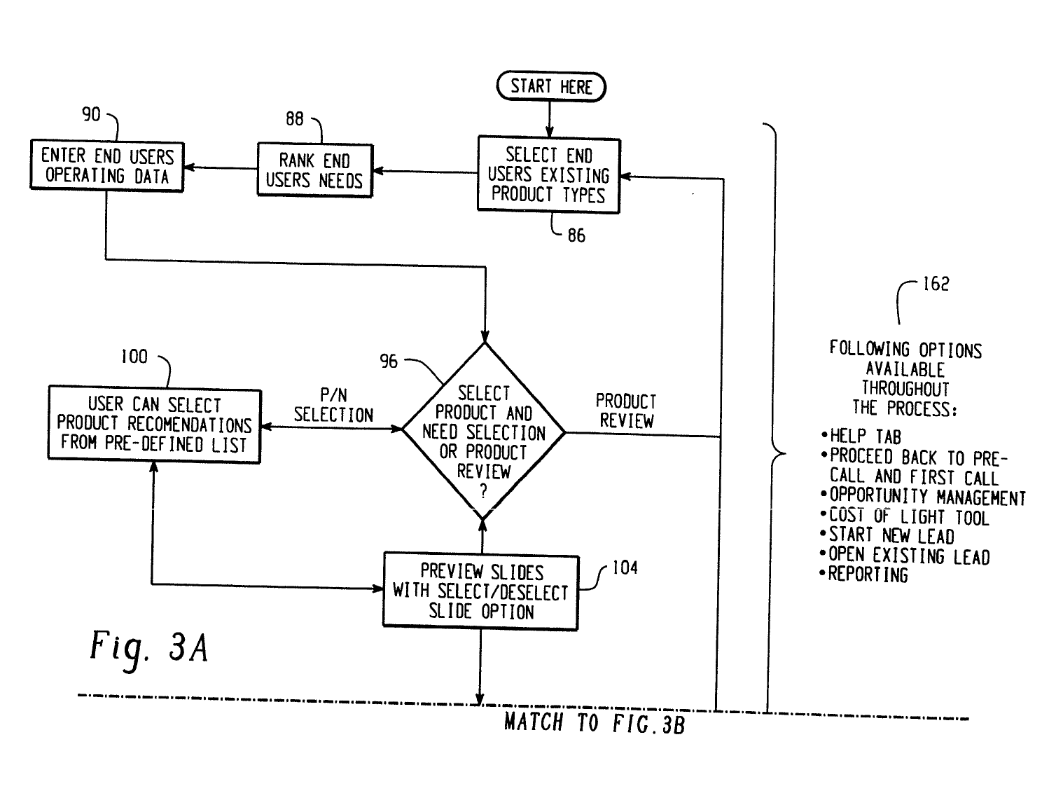

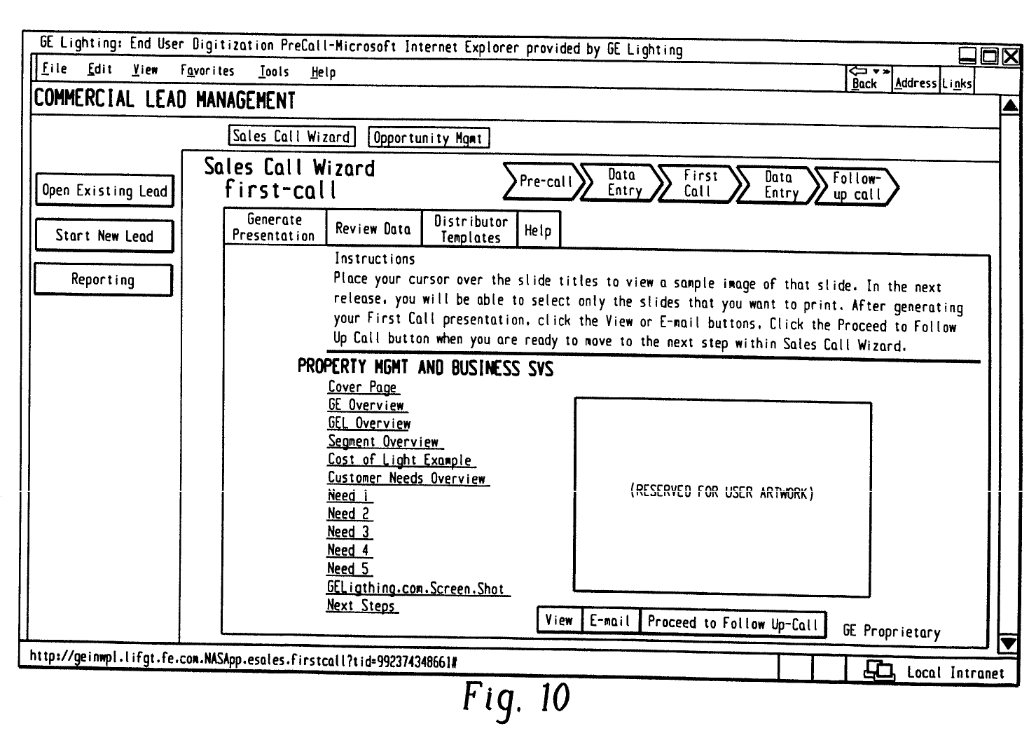

Employing the newly obtained data, and as illustrated in FIG. 3, arriving at step 86 by selecting the Proceed to Follow Up Call button, the user selects end user's products from a listing of typical existing products. This procedure is shown, for example, in FIG. 11 where the End User Product section 87 has checkmarks by products corresponding to those products currently used by the end user. It is to be understood the products from which the user will make the selection are appropriate for the previously selected category. Therefore, products which in a particular market segment, for example, Warehouses or Utilities but not for Property Management and Business Services, would not be included in the list. Specifically, the SCW tool 10 will present the user only with those products appropriate for a selected segment.

The next step in the process flowchart of FIG. 3, step 88, has the user rank the customer's needs. In step 90 the user inputs end user operating data. Thus, in End User Needs section 92, a ranking of the variables important to a specific end user is provided. The user (e.g. Sales Rep or Distributor) has obtained this information from the customer during the first call presentation. For example, in FIG. 11 Tenant Satisfaction is ranked as No. 1. Utility Optimization is No. 2, Labor/Productivity is No. 3, Safety and Security No. 4 and Environmental Concerns is rated No. 5.

Calculation data, indicating the annual hours the user operates the products, the energy rate at which operation occurs and the date of the follow-up presentation are then entered in the Calculation section 94.

Once the data has been inserted into the appropriate fields, the process moves to step 96. At this point, the user is presented with an opportunity to select Product and Customer Needs Selections tab 98. Selection of the Product and Customer Needs Selections tab 98, which causes the supplied data to be input into the system allowing SCW tool 10 determine replacement products meeting the needs of the customer. The SCW tool makes selections based upon the data input to the End User Needs ranking section 92, and the customer existing products section 87. More particularly, there is an upsell (or product replacement) database for the selected market segment wherein links are provided from existing products to alternative products based on the input data. Algorithms which provide the suggested replacement products are well known to one of ordinary skill in the art.

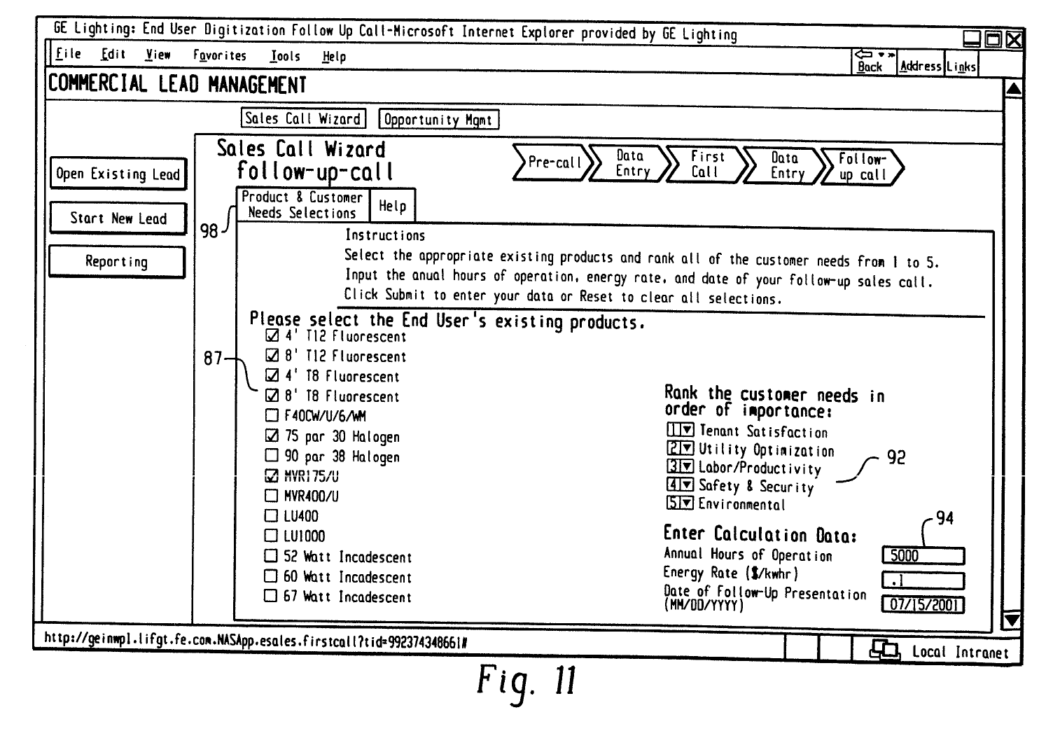

When the Select Product and Need Selection tab 98 is selected, and the process moves to step 100, the screen of FIG. 12 is generated. This screen displays the recommendations returned based on the user's existing products and primary needs. If it is necessary to change the recommendations, the user simply clicks on a button next to the new selection. Clicking on the Submit button allows the process to continue, whereas selecting the Cancel button returns the operation to the prior screen.

Alternatively, as shown in FIG. 12, selection of Review tab 99 (step 96), causes the process to cycle back through steps 86, 88 and 90, where the user may make new data inputs.

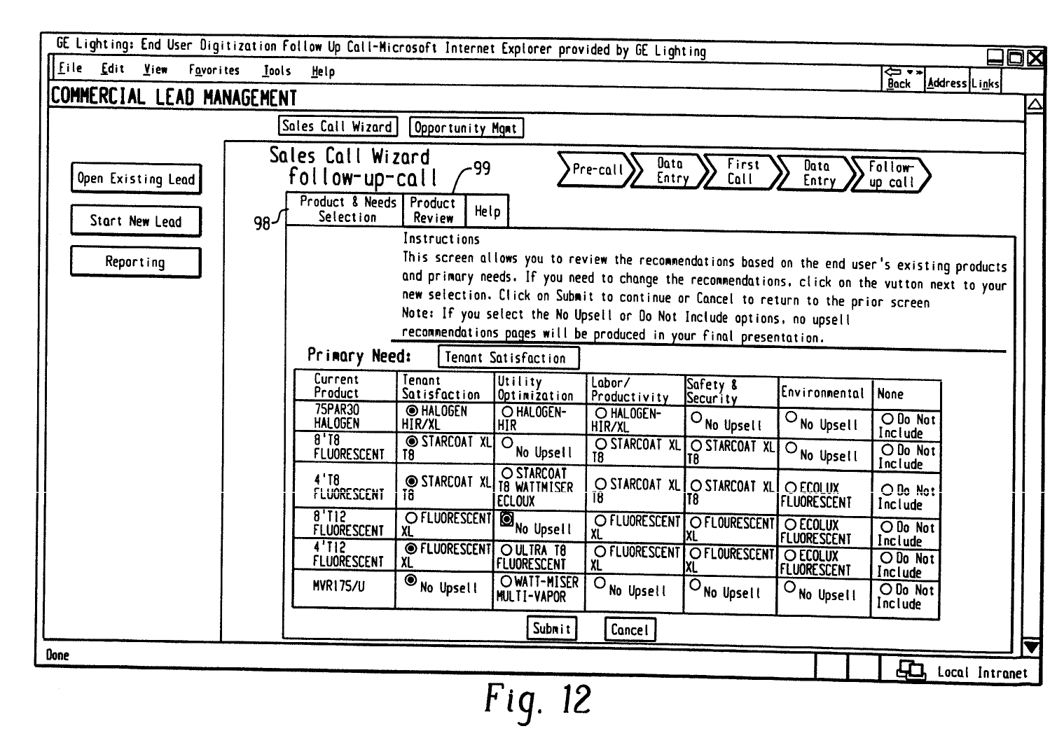

Once the user has determined that the appropriate products are selected and the recommendations accepted, the process moves to step 104 where the user is allowed to preview the slides corresponding to the proposed presentation, including those specific slides including the new recommended products. FIG. 13 shows the screen which may be used by the user at this point in time. Included on the screen is the Follow-up Sales Presentation Slide Description section 105. By placing a selection mechanism, such as a mouse, over one of the description areas, a corresponding preview slide is shown in the Preview Slide section 106.

Following a determination that the presentation is appropriate, the process flow of SCW tool 10 in FIG. 3 moves to step 110. At decision step 110, the user may generate the presentation by selection of the Generate button, review data entered by selection of the Presentation Data Review tab 108, or a further review of the product review may be undertaken by selection of the Product Selection Review tab 109. An alternative decision at this point may also be made to download the distributor template. When the user selects the download template or blank template, the process moves to step 112 where a static or customizable distributor template is downloaded. When the Presentation Data Review tab 108 is selected, the process moves to step 114 the user is provided with the ability to change the end user and distributor data. Appropriate screens for entry of this data are resupplied, allowing the user to review and/or change this information. It is noted the product review capability may be achieved by use of the buttons generated while at decision block 96. When the data has been entered correctly, selection of the submit button of FIG. 12 allows the process to proceed.

Decision step 110 further permits the user to generate the customized presentation when the user is satisfied with its contents. This moves the process to step 118 wherein the user is provided with an ability to change or omit initial product recommendations. After accepting or changing the product recommendations the process moves to decision step 120 wherein the user may view, e-mail or download a distributor template for further customization. Once the process has been completed, and the user is satisfied with the final follow-up customized presentation, the user may e-mail the finalized version to his e-mail account 122, view the customized presentation on the PC, save and/or print the material 124.

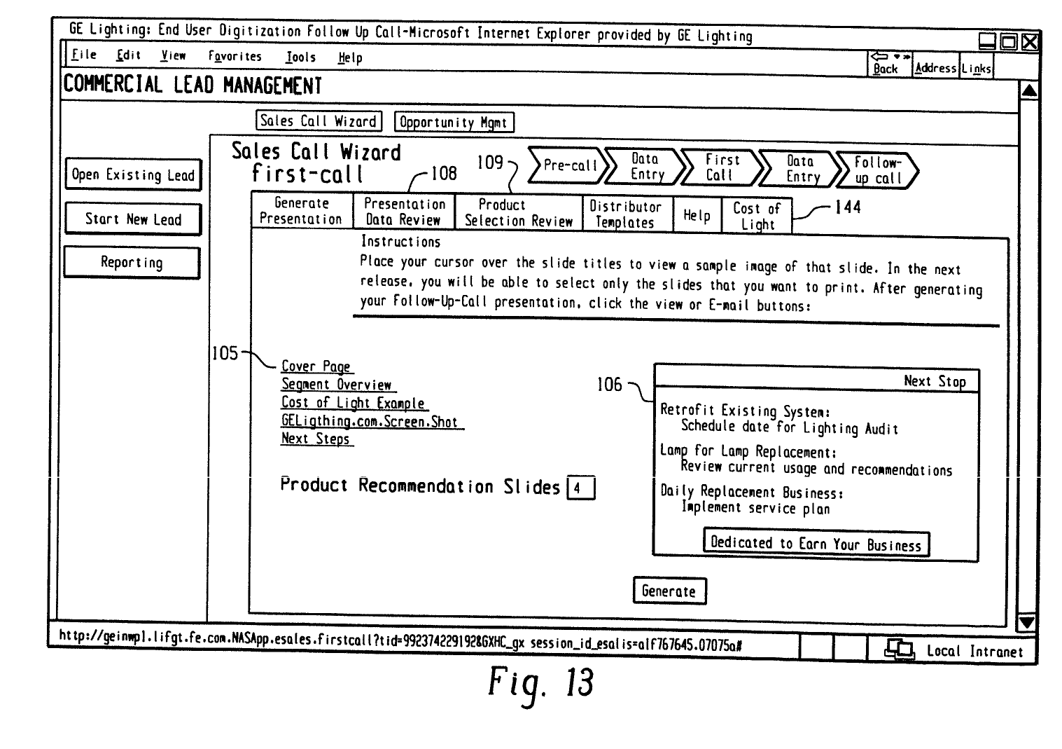

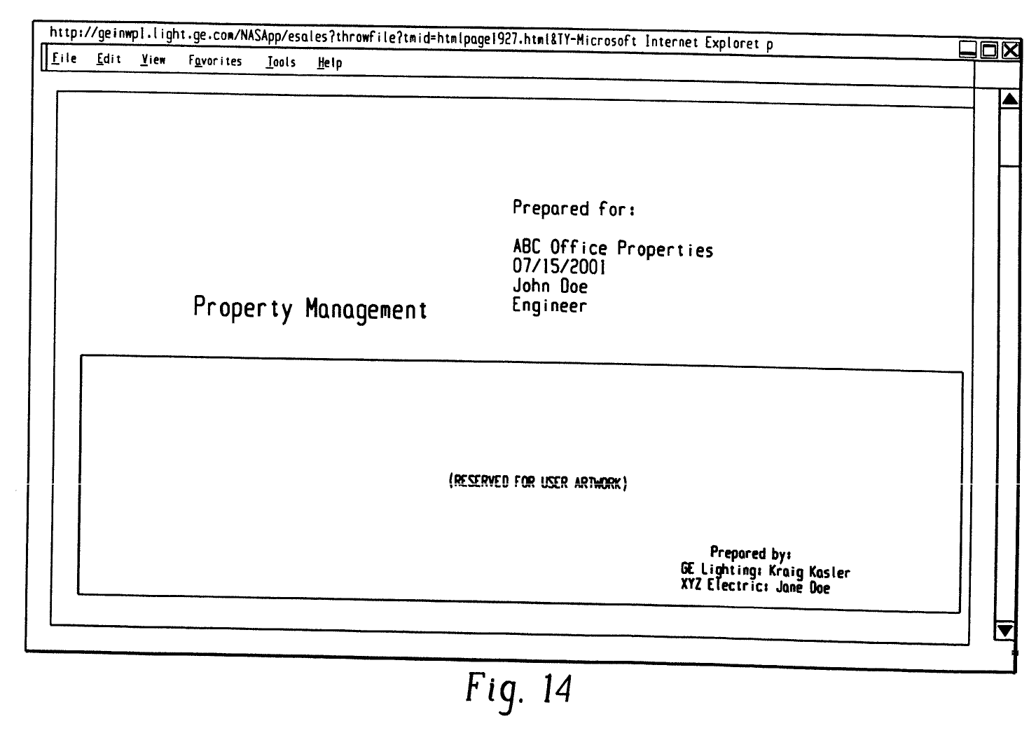

The finalized, customized version of the sales presentation, where an exemplary cover sheet is shown in FIG. 14, will have the specific end user to which the presentation is being shown, and the parties who have prepared the presentation. As part of the presentation, and as shown in FIG. 15, product recommendations are provided where for example an existing product 130 is shown and its recommendation product 132 is also illustrated and described in detail.

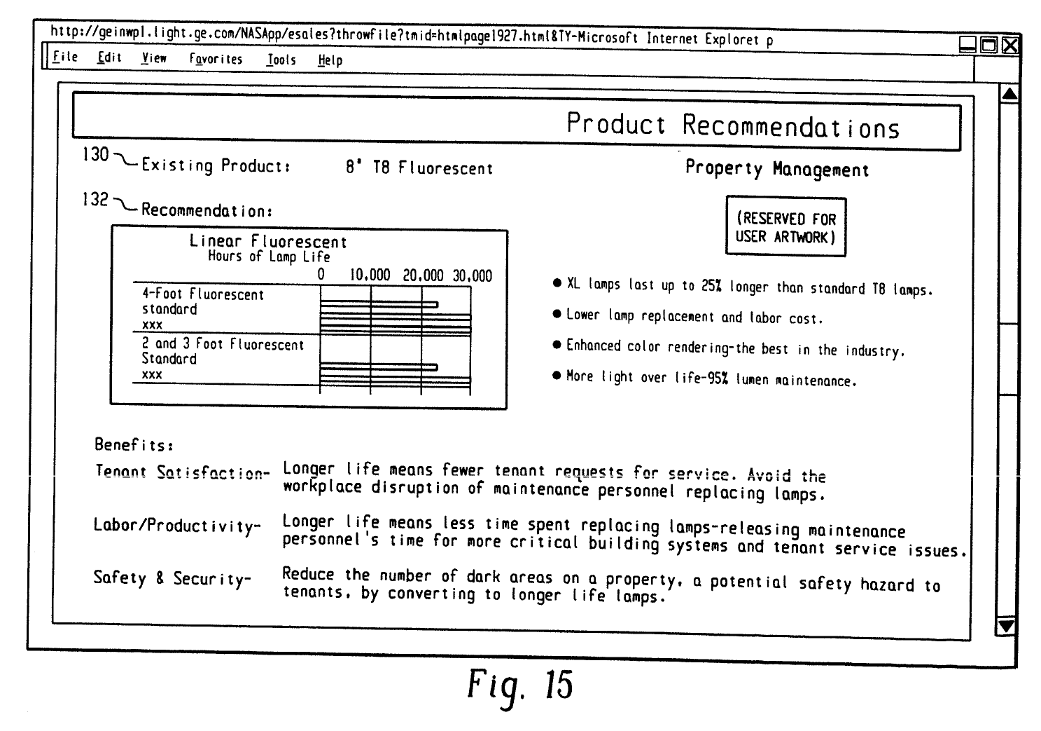

Returning attention to FIG. 13, a further tab presented is a Cost-of-Light tab 144. Selection of this tab permits the user to activate a tool for evaluating in a more detailed manner the cost associated with a user's needs. More particularly, selection of Cost-of-Light tab 144 activates a Cost-of-Light tool 148 whose process flow is shown in FIG. 16. In step 150 the user inputs general customer contact information. In step 151 the user inputs data regarding existing lighting system information of a facility being audited. This information includes the present day operating costs of the end user, a facility-by-facility or room-by-room audit of the fixtures and lighting of each individual room, the energy costs, labor costs, maintenance cost of the system, etc.

Next in step 152, the user inputs the proposed replacements and/or products for the facility or area described in step 150 or, selectively, the system generates the proposed replacements and/or products in step 153. The information on the products in step 152 or step 153 includes the various operating statistics and parameters of the upsell products. This information, in connection with step 152 or step 153 is then used in calculations of step 154 wherein step 154 calculations take into consideration the aspects of the facility described in step 151. Calculations of 154 include values with regard to various topics such as energy cost, labor cost, maintenance cost, overall operating cycles, return on an investment and environmental impact, among others. In step 158, the user reviews the calculations of step 154 in accordance with these various categories between the information of step 151, the existing system, and the system as operating using the upsell products. Step 160 then generates a report or presentation presentable to an end user.

By this design, a system for evaluating the cost of lighting is integrated into the Sales Call Wizard tool 10. This feature adds greater functionality for a user.

In FIGS. 1-3, additional options which are available throughout the process 162 may be shown to a user by tabs, pulldown screens or other known activation tools. During different steps of the process, alternative options and flows are possible. For example, in FIG. 1, the Introduction tab and the Help tab are noted to be available throughout the process. In an alternative embodiment, the Cost of Light tool 148 is integrated to be activated at any time during the use of the Sales Call Wizard Tool 10. Particularly, in alternative embodiments a Cost-of-Light tab is presented in each of the screens similar to or the same as the Help tab as presently shown. It is to be understood that selection of this Cost-of-Light tab provides a direct link to the Cost-of-Light tool integrated into the system.

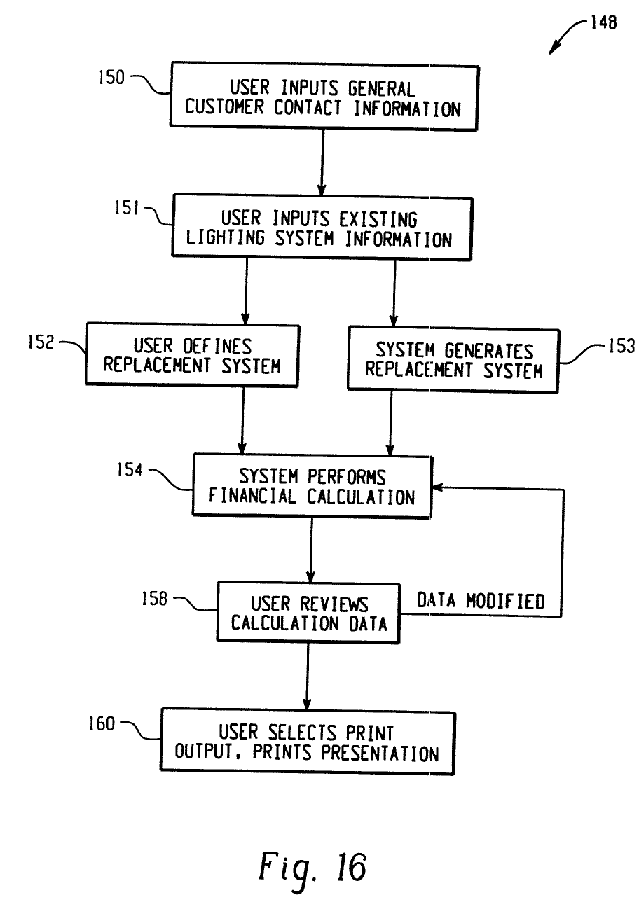

In yet another embodiment, the flowcharts of FIGS. 1-3 are altered to interpose a step for activating an Opportunity Management System, step 164 for example, between steps 12 and 14 of FIG. 1, as now shown in FIG. 17. In this embodiment, the Opportunity Management System becomes operational upon entry into the SCW tool 10. Within step 164, A user first selects a new Opportunity Management System (OMS) entry in step 166. The user then populates required and/or optional fields, and saves the new entry in step 168. At decision step 170, the user then decides whether to return to step 168 to add another new OMS entry or to select the SCW and continue with step 14.

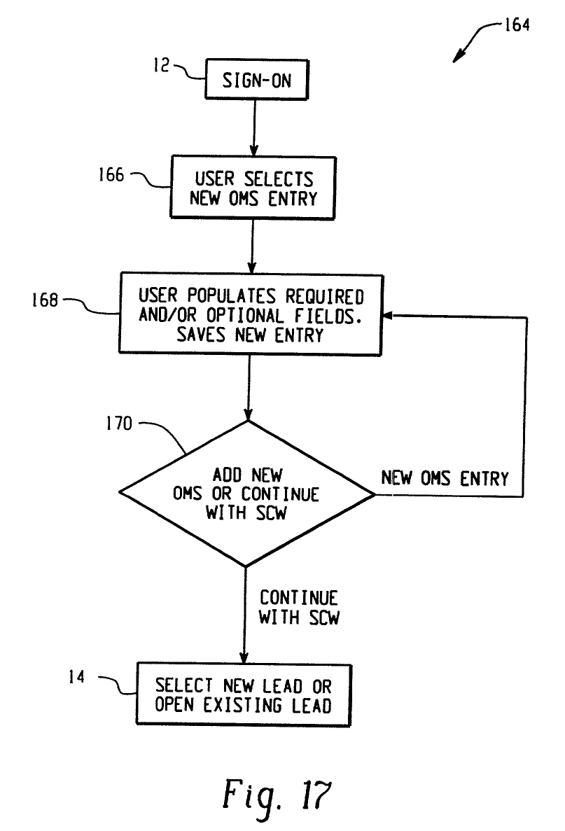

In FIG. 18, an alternative embodiment permits an active selection of the Opportunity Management System, steps 172 and 174 between steps 14 and 35 of FIG. 1 where a user has chosen to open an existing lead. Specifically, a decision step 172 requests whether the existing SCW is to be added to the Opportunity Management System. If yes, the system is activated and the user enters remaining OMS required fields and/or optional data and saves the data in step 174, and if no, the system passes to step 35.

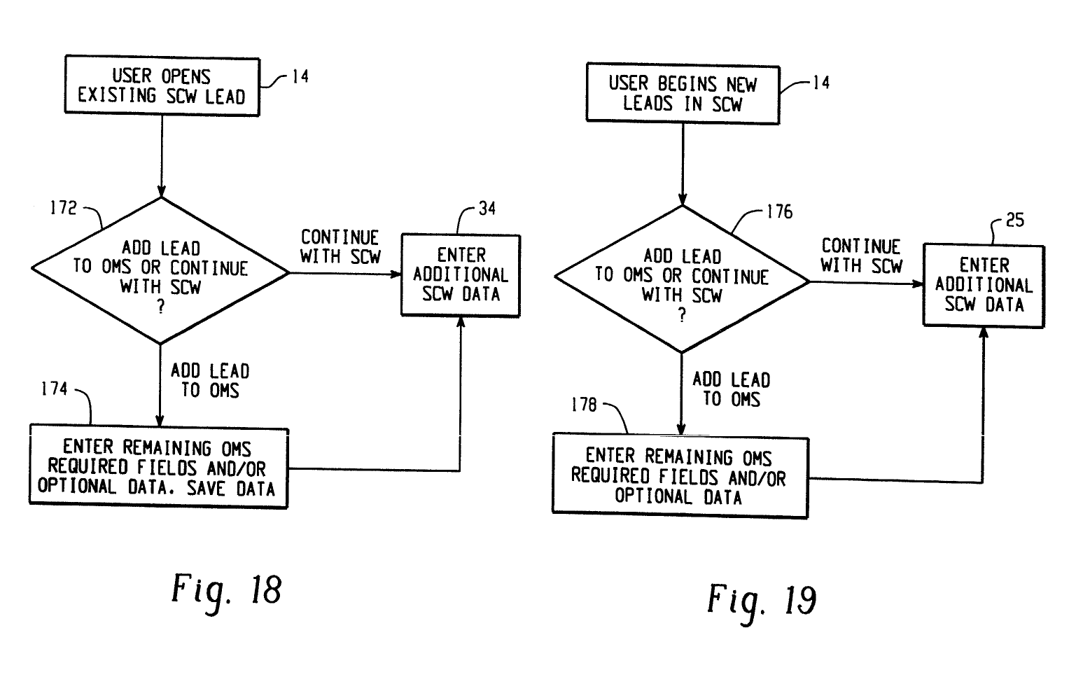

In FIG. 19, another alternative embodiment permits an active selection of the Opportunity Management System, steps 176 and 178 between steps 14 and 22 of FIG. 1 where a user has chosen to start a new lead. Specifically, a decision step 176 requests whether the new SCW lead is to be added to the Opportunity Management System. If yes, the system is activated and the user enters remaining OMS required fields and/or optional data and saves the data in step 178, and if no, the system passes to step 22.

It is to be appreciated, that while the activation of the Opportunity Management System is shown to occur immediately following the sign-in of a user name and password in step 12, or immediately following opening of an existing SCW lead at step or starting a new SCW lead at step 14, such selection may be made at other points within the flow process.

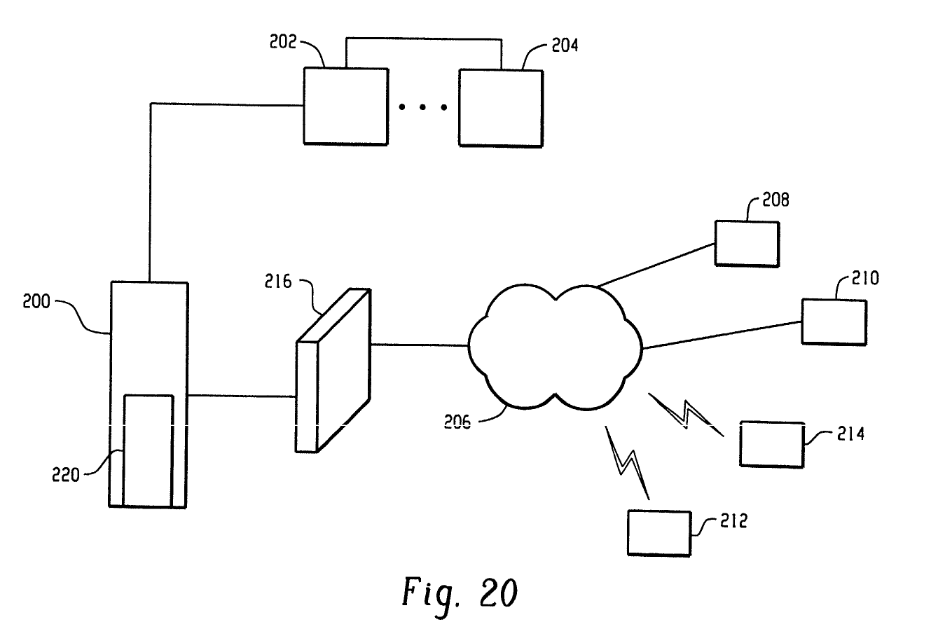

SCW tool 10 and integrated components are configured to operate from a server 200 such as shown in FIG. 20 and may be used both in an Intranet-based system for users connected to the Intranet 202,204, and via the Internet 206, for users using both wire line 208,210 and wireless 212,214 connections. A firewall, 216 is shown for security reasons between the system's internal server and the Internet. Server 200 or other electronic device containing electronic storage hold data in appropriate databases 220 as described in this discussion.

The system of the present invention provides customized images which permits a dynamic collection of information. The system maintains that information for use in the future. In other words, this is not a text-based system wherein data is generated from a database, for a specific request, but the data is not maintained. Further, the data received from the sales rep or the distributor is dynamically used to generate the customized presentations. This permits the customized presentations to be recalled, updated, and resaved as well as e-mailed, printed or downloaded for further use. Thus, the input by the sales representative and the distributors are determinative of the output presentations.

The present invention therefore provides an ability to customize end user product recommendations and to generate them into presentations that are accessible both by internally connected users such as an Intranet user as well as exterior sales reps or users such as through the Internet. The system generates product recommendations through this dynamic process including light cost calculations and sales management reports.

The foregoing is considered as illustrative only of the principles of the invention. Further, since numerous modifications and changes will readily occur to those skilled in the art, it is not desired to limit the invention to the exact construction and operation as shown and described, and accordingly, all suitable modifications and equivalents may be resorted to falling within the scope of the invention.

What is claimed is:

1. A tool for generating sales presentations comprising:
a lead page configured to include a selectable new lead button and a selectable existing lead button, wherein leads are sales presentations;
a new lead data entry page linked to the new lead button having defined data entry requirements to permit generation of a new lead;
an existing lead page linked to the existing lead button designed with a listing of existing leads callable by a user;
a lead generation page which generates a first call sales presentation, dynamically using data entered by the user;
a follow-up call data entry page having data entry sections, for entering data specific to a customer, the data obtained during presentation of the first call sales presentation to the customer;
a product replacement page which generates replacement or upgrade products for a customer; and
a follow-up sales presentation page for generating a follow-up sales presentation for the customer including the replacement of upgrade products.

2. The invention according to claim 1 further including, a pre-call data page having a plurality of selectable market segments, wherein selection of one of the market segments generates a pre-call data sheet related to the selected market segment.

3. The invention according to claim 1 wherein the tool integrates a Cost-of-Light tool, which generates reports related to a customer's costs to maintain its lighting system.

4. The invention according to claim 1 when the tool integrates an opportunity management system which generates reports regarding management of the sales process.

5. The invention according to claim 1 wherein the tool functions in an Intranet environment.

6. The invention according to claim 1 wherein the tool functions in an Internet environment.

7. The invention according to claim 1 wherein the tool functions in a wireless environment.

8. The invention according to claim 1 further including a sing-in page configured to authenticate an approved user of the tool.

9. A method for generating sales presentations comprising:
accessing a lead page displaying a selectable new lead button and a selectable existing lead button, wherein leads are sales presentations;
selecting one of the new lead button and the existing lead button;
moving, when the new lead button is selected, to a new lead data entry page linked to the new lead button, the new lead data entry page having defined data entry requirements to be made by a user to permit generation of a new lead;
moving, when the existing lead button is selected, to an existing lead page linked to the existing lead button, the existing lead page designed with a listing of existing leads callable by the user;
entering, by the user, data in at least one of the new lead data entry page or the existing lead page;
moving from one of the new lead data entry page or the existing lead page to a lead generation page;
generating, at the lead generation page, a first call sales presentation, dynamically using data entered by the user;
moving to a follow-up call data entry page having data entry sections;
entering at the follow-up call data entry page, data specific to a customer, the data obtained during presentation of the first call sales presentation to the customer;
generating replacement or upgrade products for a customer at a product replacement page; and
a follow-up sales presentation page for generating a follow-up sales presentation for the customer including the replacement of upgrade products.

10. The method according to claim 9 further including moving to a pre-call data page having a plurality of selectable market segments, wherein selection of one of the market segments generates a pre-call data sheet related to the selected market segment.

11. The method according to claim 9 further including a cost-of-light tool, which generates reports related to a customer's costs to maintain its lighting system.

12. The tool according to claim 9 further including integrating an opportunity management system which generates reports regarding management of the sales process.

13. The method according to claim 9 further including transmitting the data and the pages within an Intranet environment.

14. The method according to claim 9 further including transmitting the data and the pages within an Internet environment.

15. The method according to claim 9 further including transmitting the data and pages within a wireless environment.

16. The method according to claim 9 further including a sign-in page configured to authenticate an approved user of the tool.
